(19) United States
(12) Patent Application Publication
(10) Pub. No.: US 2017/0042093 A1
(43) Pub. Date: Feb. 16, 2017

(54) Guiding Device for a Baler

(71) Applicant: DEERE & COMPANY, MOLINE, IL (US)

(72) Inventors: EMMANUEL CHAPON, VELET (FR); SEBASTIEN GUERIN, AUDEUX (FR); MICHAEL BAKER, BRIMFIELD (GB)

(21) Appl. No.: 15/238,043

(22) Filed: Aug. 16, 2016

(30) Foreign Application Priority Data
Aug. 14, 2015 (DE) 102015215575.7

(51) Int. Cl. A01F 15/10; A01F 15/18

(52) U.S. Cl. CPC A01F 15/106; A01F 15/18

(57) ABSTRACT

A baler for producing round bales includes a harvested goods feed-in device, a pressing chamber, and a feed-in channel that has an area facing the pressing chamber and through which harvested goods can go from the harvested goods feed-in device to the pressing chamber, wherein the area of the feed-in channel facing the pressing chamber has a width that is smaller than the width of the pressing chamber. The baler may include a guiding device for reducing the width of a feed-in channel of a baler.

### CROSS-REFERENCE TO RELATED APPLICATIONS

Pursuant to 35 USC §119, this application claims the benefit of and priority to German patent application no. 102015215575.7, filed on Aug. 14, 2015, which is herein incorporated by reference in its entirety.

### FIELD OF THE DISCLOSURE

The present disclosure relates to a baler, such as an agricultural or industrial press for producing round bales.

### BACKGROUND

Known balers have a harvested goods feed-in device that receives material in the form of harvested goods, harvested goods residue, or similar material from the ground and feeds it through a feed-in channel into a pressing chamber of the baler. In the pressing chamber of the baler, a bale is formed in a suitable way, that is, it is typically pressed and then, subsequent to the pressing process, it is fixed in a suitable way, for example, wrapped with twine or in enveloped in a suitable material, and then discharged or ejected from the baler, in order to be placed, for example, on the ground or further treated in some other way.

Such balers are used both in agricultural and also industrial fields. Corresponding agricultural presses are used, for example, for forming bales of harvested goods, for example, in the form of round bales, and frequently produce at least essentially round cylindrical bales made from harvested goods, for example, in the form of straw, hay, chopped goods, etc. Industrial presses are used for compacting waste, textiles, or other materials or for pressing these into bales. These can be presses with a fixed chamber construction, but a partially or completely variable pressing chamber, in particular, with the use of pressing belts, is also conceivable.

The feed-in channel of known balers typically extends over the entire width of the pressing chamber, so that the harvested goods are brought in a wide stream into the pressing chamber. In particular, difficult harvesting conditions, for example, very dry harvested goods, can lead in such presses to an increase in the pressure in the edge areas of the pressing chamber, in particular, between the side walls of the presses and the side surfaces of the bale. In this way, the frictional forces between the side walls of the pressing chamber and the bale side surfaces are increased such that a rotation of the bale in the pressing chamber is slowed down and possibly comes to a complete standstill. This can make it impossible to form a complete bale or another bale and/or can result in a bale of lower quality.

### SUMMARY

The problem forming the basis of the disclosure is to disclose a baler or a guiding device of the type named above, which eliminates the aforementioned disadvantages.

The problem is solved according to the disclosure by the teaching of claims 1 and 7. Additional advantageous constructions and improvements of the disclosure emerge from the dependent claims.

A baler, such as an agricultural or industrial press for producing round bales, has a harvested goods feed-in device, a pressing chamber, and a feed-in channel that has an area facing the pressing chamber and through which harvested goods can go from the harvested goods feed-in device to the pressing chamber. If the area of the feed-in channel facing the pressing chamber has a width that is smaller than the width of the pressing chamber as such, then this promotes the formation of bales even under difficult harvesting conditions. Due to the geometry of the feed-in channel with a reduced width or tapered cross section in the direction of the pressing chamber, the flow of goods is guided in the direction of a central area of the feed-in channel or the pressing chamber, whereby less material goes into the edge areas of the pressing chamber. The pressure in the edge areas thus can be reduced and the friction between the side walls of the pressing chamber and the bale side walls can be influenced such that lower frictional forces occur. In this way, a slowing down of the rotation of the bale in the pressing chamber and especially a complete blockage can be prevented.

If the width of the feed-in channel successively decreases in the direction of the pressing chamber at least in some areas, and in the area facing the pressing chamber, this supports a continuous flow of material. In particular, buildups and possible blockages caused by accumulating material can be further prevented.

It can be provided that the feed-in channel as such, or corresponding walls of the feed-in channel, which can optionally also be formed by side walls of the bales or connected indirectly or directly to these walls, have a previously described geometry. However, for production-related reasons or for increasing the flexible adaptation of the baler, for example, to environmental or harvesting conditions, at least one guiding device can be provided that reduces the width of the feed-in channel and is arranged at least essentially in the area of the feed-in channel facing the pressing chamber.

The guiding device can be provided fixed in the feed-in channel, for example, by being connected rigidly to at least one side wall of the feed-in channel. It is also conceivable, however, to provide the guiding device in a detachable way, in order to allow, in a simple way, a flexible adaptation of the baler to changing harvesting conditions.

It is especially simple in production or installation if the guiding device has at least one guide means, in particular, a guiding plate or guiding sheet. In some embodiments, there is only one guide means, and in other embodiments, there are two guide means having a mirror-symmetric construction with reference to a longitudinal axis of the baler.

The press can be constructed as a press with a variable or also partially variable pressing chamber and/or pressing belts, pressing rollers, or other pressing means, or also combinations of these elements. Alternatively, the press has a fixed chamber construction in the form of a press with pressing rollers.

A guiding device for reducing the width of a feed-in channel of a baler with the previously described features can be provided on an agricultural or industrial press for producing round bales. Such a guiding device can be used, for example, as a replacement part or also for retrofitting or modifying a baler in order to achieve the described advantages.

The guiding device can be provided fixed in the feed-in channel. If it is detachable, however, then this simplifies installation and/or removal or possible replacement, retrofitting, or modification.

With reference to the drawing that shows an embodiment of the disclosure, the disclosure and other advantages and additional advantages and advantageous improvements of the disclosure and construction of the disclosure will be described and explained in more detail.

### BRIEF DESCRIPTION OF THE DRAWINGS

Shown are:

FIG. 1, a baler in side view with a guiding device arranged in a feed-in channel,

FIG. 2, a schematic front view of the press with empty pressing chamber, and

FIG. 3, a representation according to FIG. 2, wherein a bale is shown in the pressing chamber.

### DETAILED DESCRIPTION

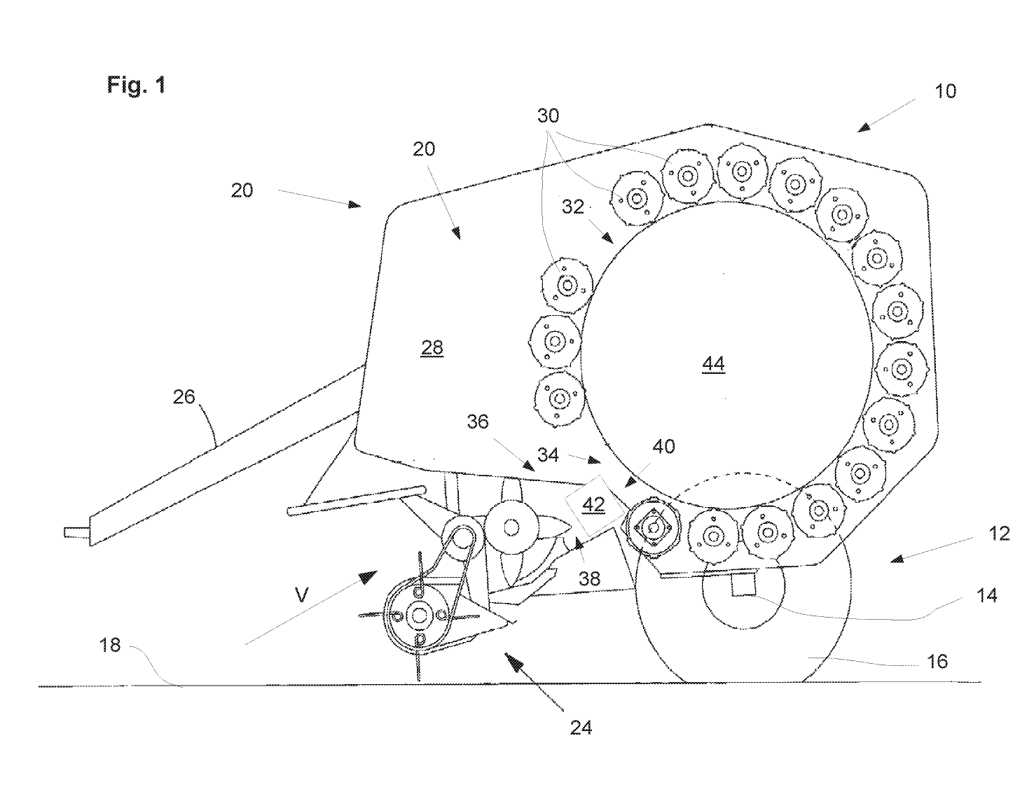

FIG. 1 shows a baler 10 for producing a pressed product in the form of a bale 12. The shown baler 10 is constructed in the form of a round baler and can be used both in agricultural and also industrial fields for producing a round, cylindrical bale 12, typically designated as a round bale from harvested goods, but also from waste, paper, fabric or textile, cotton, tobacco, etc. Such a baler 10 can be pulled by a not-shown work vehicle, for example in the form of a tractor, or can also have a self-propelled construction.

The press 10 has a chassis 12 that is supported on the ground 18 by means of an axis 14 with wheels 16, a housing 20 with side walls 22, a harvested goods feed-in device 24, and a drawbar 26 by means of which the baler 10 can be attached to the not-shown work vehicle.

Inside the housing 20 there is a pressing chamber 28 that extends between the two side walls 22 and is surrounded by a plurality of rollers 30 arranged at least essentially on a circle, wherein the rollers 30 have, in the front area of the baler 10, an upper gap 32 for a not-shown attachment device and a lower gap 34 for the harvested goods feed-in device 24.

Between the harvested goods feed-in device 24 and the pressing chamber 28 extends an area that is designated below as the feed-in channel 36 and through which harvested goods can go from the harvested goods feed-in device 24 into the pressing chamber 28 and has the area 38 facing the harvested goods feed-in device 24 and an end area 40 facing the pressing chamber 28. In the feed-in channel 36 there is a guiding device 42.

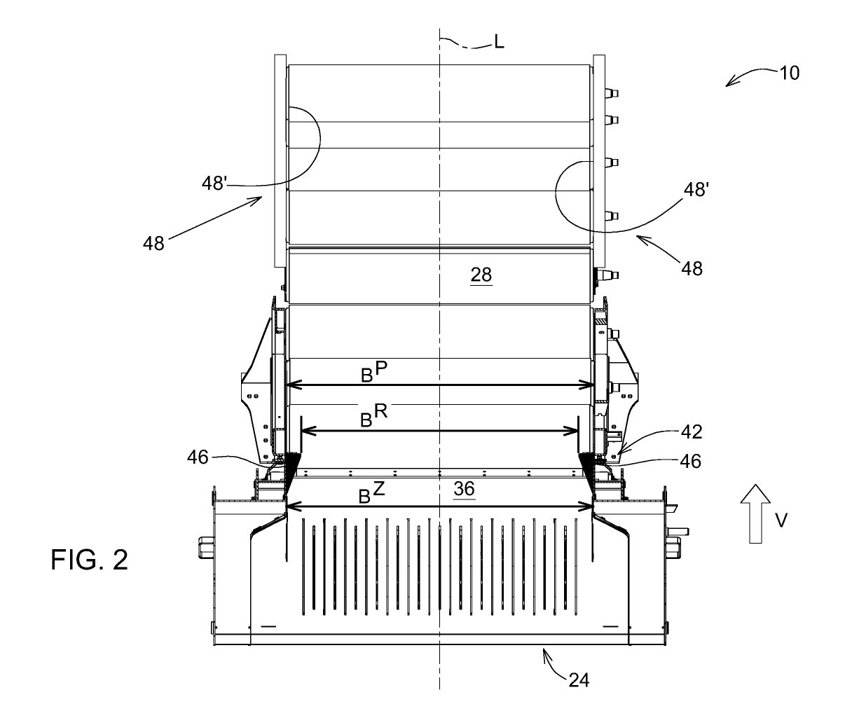

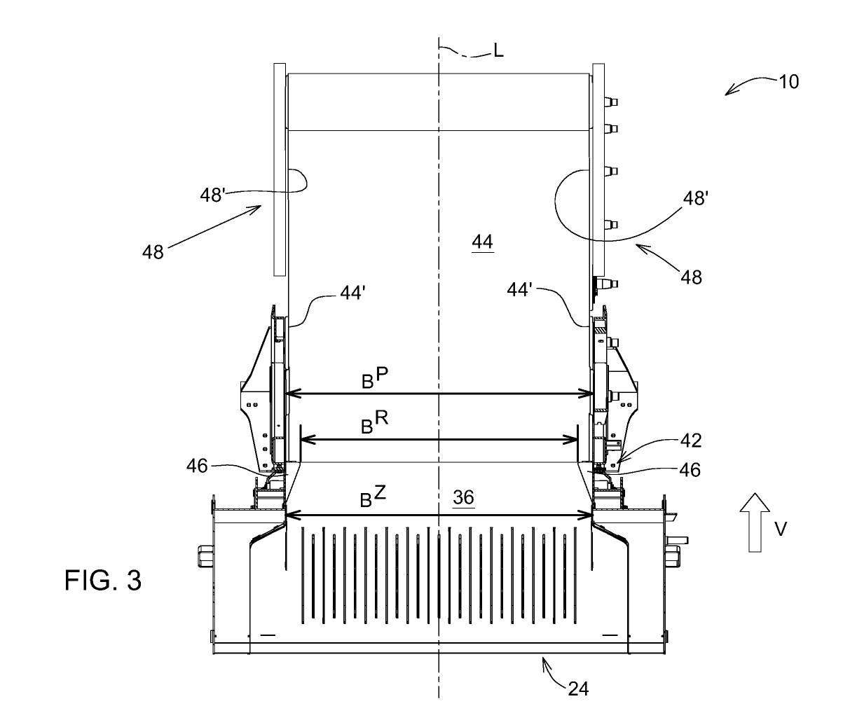

Reference is now also made to FIGS. 2 and 3, wherein FIG. 2 shows a front view of the baler 10 with empty pressing chamber 28 and FIG. 3 shows a front view in which a bale 44 is arranged in the pressing chamber 28.

In general, the feed-in channel 36 has an open width B. From FIGS. 2 and 3, however, it is clear that the feed-in channel 36 has a first width B^{Z} in the area 38 facing the harvested goods feed-in device 24 and a second width B^{R} in the area 40 facing the pressing chamber 28, wherein the width B^{R} of the area of the feed-in channel 36 facing the pressing chamber 28 is smaller than the width B^{Z} of its area 40 facing the harvested goods feed-in device 24.

The reduction of the width B of the feed-in channel 36 is caused by means of a guiding device 42 that has two guide means 46 with a mirror-symmetric construction relative to a longitudinal axis L of the baler 10. According to the present embodiment, the guide means 46 are constructed in the form of guide plates or guide sheets that are provided on side walls 48 of the baler 10 and that extend inward with respect to the direction of flow of material (see arrow V) in the normal operation of the baler 10 from the side walls 48 with increasing distance and thus taper the feed-in channel 36 in the direction of the pressing chamber 28 or reduce its open width B.

Below, the function of the baler 10 in normal operation and here, in particular, the effect of the guiding device 42 will be discussed in more detail.

In the normal operation of the baler 10, harvested goods or corresponding harvested goods residue that has already been cut and is typically lying on the ground is picked up by the harvested goods feed-in device 24 and brought into the baler 10 along the direction of the flow of goods designated with V. The harvested goods further go through the feed-in channel 36 into the pressing chamber 28, in order to be compacted there into a bale 44 and ejected after the formation of the bale is complete.

During the procedure of forming the bale, the bale 44 is set in rotation in the pressing chamber 28, whereby a greater or smaller amount of friction can occur between bale side surfaces 44′ and the side surfaces 48′ of the side walls 48 of the pressing chamber 28 as a function of the harvested goods and/or its state.

The guiding device 42 or, in particular, the guide means 46 reduce the width of the feed-in channel 36 in the direction of the pressing chamber 28 such that the flow of goods going into the pressing chamber 28 tapers, or the outlet from the feed-in channel 36 has a reduced width with respect to the rest of the feed-in channel 36 or to the pressing chamber 28. Thus, a reduced quantity of material is fed in the direction of the side walls 48 of the pressing chamber 28, whereby the pressure is reduced between the inward-facing side surfaces 48′ of the side walls 48 and the bale side surfaces 44′. In this way, the friction between the bale 44 and the side walls 48 or between the bale side walls 44′ and the side surfaces 48′ of the side walls 48 is reduced and thus a blockage of the bale 44 in the pressing chamber 28 is prevented or counteracted.

The guiding device 42 or the guide means 46 are constructed such that the width B of the feed-in channel 36 is successively and continuously reduced. The flow of goods is little by little compacted together by the guiding device 42 in the direction of the flow of goods V, so that it enters into the pressing chamber 28 with reduced width B2. Through the gradual reduction of the width of the flow of goods, a buildup of material on the guiding device 42 or on the guide means 46 is counteracted and this prevents blockage of the feed-in channel 36.

1. A baler comprising:
a harvested goods feed-in device,
a pressing chamber, and
a feed-in channel that has an area facing the pressing chamber and through which the harvested goods can go from the harvested goods feed-in device to the pressing chamber,
wherein the area of the feed-in channel facing the pressing chamber has a width that is smaller than the width of the pressing chamber as such.

2. The baler of claim 1, wherein the width of the feed-in channel successively decreases in the direction of the pressing chamber at least in the area facing the pressing chamber.

3. The baler of claim 1, further comprising:
a guiding device arranged at least essentially in the area of the feed-in channel facing the pressing chamber, the guiding device reducing the width of the feed-in channel.

4. The baler of claim 3, wherein the guiding device is provided fixed or detachable in the feed-in channel.

5. The baler of claim 3, wherein the guiding device has at least one guide means, in the form of a guide plate or sheet, wherein at least two guide means are provided that have a mirror-symmetric construction with reference to a longitudinal axis of the baler.

6. The baler of claim 1, wherein the baler is constructed in the form of a fixed chamber press.

7. A guiding device for reducing the width of a feed-in channel of a baler, comprising:
at least one guide means in the form of a guide plate or sheet.

8. The guiding device of claim 7, wherein the guiding device is provided fixed or detachable in the feed-in channel.

9. The guiding device of claim 7, wherein the guide means includes two guide plates or sheets having a symmetric construction with reference to a longitudinal axis of the baler.
